(19) United States
(12) Patent Application Publication
(10) Pub. No.: US 2025/0115494 A1
(43) Pub. Date: Apr. 10, 2025

(54) REMOVAL OF VIRUSES FROM WATER BY FILTRATION

(71) Applicant: INSTRACTION GMBH, Heidelberg (DE)

(72) Inventors: Martin WELTER, Neckargemuend (DE); Christian MEYER, Schwetzingen (DE); Kristian LUNGFIEL, Neueibau (DE)

(73) Assignee: INSTRACTION GMBH, Heidelberg (DE)

(21) Appl. No.: 18/294,612

(22) PCT Filed: Aug. 4, 2022
(86) PCT No.: PCT/EP2022/071890

§ 371 Date: Feb. 2, 2024

(30) Foreign Application Priority Data
Aug. 5, 2021 (DE) 10 2021 120 424.0

(51) Int. Cl. C02F 1/28; B01J 20/10; B01J 20/32; B01J 41/07; B01J 41/14; B01J 47/016

(52) U.S. Cl. CPC C02F 1/288; B01J 20/103; B01J 20/3204; B01J 20/321; B01J 20/327; B01J 20/3282; B01J 41/07; B01J 41/14; B01J 47/016; B01J 2220/62; C02F 2303/04

(57) ABSTRACT

The present invention relates to a method for producing antiviral particles and to the particles themselves, which can be produced by the method according to the invention. The particles according to the invention are used to remove viruses from water, but also to remove biological impurities from water and to bind metal-containing ions from solutions. The present invention also relates to a filter cartridge containing particles according to the invention.

The present invention relates to a process for the production of antiviral particles and to the particles themselves, which can be produced by the process according to the invention. The particles according to the invention are used to remove viruses from water, but also to remove biological impurities from water and to bind metal-containing ions from solutions. The present invention also relates to a filter cartridge containing particles according to the invention.

Biological contamination of drinking water is a well-known and critical problem, particularly in warmer regions of the world. Even after natural disasters, wells are contaminated with bacteria, germs and viruses. Heavy metals in drinking water also continue to pose a problem.

Viruses in particular are difficult to remove physically due to their small size. Alternatives are chlorination, ozonization, UV irradiation, membrane filtration and the like. These processes are sometimes very energy-intensive (high pressure) and expensive, require the use of chemicals or reduce the water quality in other respects, for example due to a significant chlorine flavor. The water may have to be boiled or filtered through activated carbon to remove the chlorine. Furthermore, some of the techniques, e.g. membrane filtration, only provide low yields, as a large proportion of the water is lost during the process.

State-of-the-art water purification systems, such as softening systems, water dispensers with and without purification modules, are always suspected of being contaminated and must be carefully cleaned. Swimming pools that do not chlorinate the water and use biological purification stages often struggle with viral and bacterial contamination in the warmer months of the year. In households with a hot water tank, this must always be kept above a certain high temperature in order to prevent listeria contamination. Systems with closed water circuits also require sterilization processes to maintain the water quality, for example in industrial cooling water circuits.

The removal of undesirable metal ions, in particular heavy metal ions, from drinking water is also important in this context.

WO 2017/089523 and WO 2016/030021 disclose a sorbent for removing metal ions and heavy metal ions from water as well as a manufacturing process for such a sorbent. However, the materials disclosed in these publications have only a low biocidal effect and no antiviral effect.

There was therefore a need for an improved sorbent which, in addition to biological impurities and heavy metals, can also safely remove viruses from drinking water.

The task was solved by a process for the production of antiviral particles comprising the following steps:
(a) preparing an aqueous suspension containing a polyamine, a crosslinking agent and an inorganic carrier material or an organic carrier material in particle form at a temperature of less than or equal to 10° C. in a mixer for coating the inorganic carrier material or the organic carrier material with the polyamine;
(b) crosslinking the polyamine of the coated inorganic carrier material or the coated organic carrier material and simultaneously removing water,
(c) protonating the crosslinked polyamine to obtain antiviral particles.

Steps (a) and (b) can be repeated at least once. This can be important if a high concentration of amino groups is required, for example a concentration of more than 600 [symbol] mol/g.

Surprisingly, it was found that, on the one hand, this process can provide a less complex production method for the sorbent compared to the prior art. In addition, the sorbent produced in this way does not tend to form biofilms and shows a very high biocidal effect against bacteria and germs and, due to the protonation, also a very high effectiveness against viruses. The increased effectiveness against viruses due to protonation was surprising. The effect against bacteria and germs was also increased.

According to the invention, the coating and cross-linking preferably takes place in a stirred reactor, for example a Loedige mixer. This has the advantage over crosslinking in suspension, as the crosslinking can simply be carried out in the pores of the already partially crosslinked polymer and in non-critical water. In contrast to the coating from step (a), the temperature in step (b) is increased. In step (a), a temperature of less than or equal to 10° C. is preferably selected. In step (b), crosslinking occurs almost predominantly in the pores of the preferably porous carrier material and at the same time the solvent water is removed during crosslinking, so that step (a) and consequently step (b) can be repeated in the same apparatus. Steps (a) and (b) can be repeated until the desired degree of coating and density of amino groups is achieved. It is preferable to coat only one time. However, it is also possible to coat and crosslink at least twice, but it is also possible to coat and crosslink three, four or more times. One time is most preferable. Preferably, at the end of the coating and crosslinking, i.e. before step (c), the temperature is raised and maintained at about 60° C. for about 1 hour.

It is particularly preferred that the sorbent is post-crosslinked before step (c). Preferably, this is done with epichlorohydrin and diaminoethylene at a temperature of 80-90° C., preferably 85° C., by alternating addition of the reagents.

In step (c), the amino groups of the polyamine are protonated at a pH<7, preferably <6, most preferably <5.5. It is assumed that the protonated amino groups come into contact with the viral envelope and also the bacterial envelope and destroy the envelope.

According to a further embodiment of the invention, the polyamine is used in a non-desalinated state. Hydrolysis of the polyvinylformamide accessible by polymerization with sodium hydroxide solution and subsequent blunting with hydrochloric acid produces sodium chloride and sodium formate. The polymer solution is demineralized by membrane filtration, in which the polymer is retained while the salts penetrate through the membrane layer. Membrane filtration is continued until the salt content according to the ashing residue is less than 1% of the initial weight (1% of the polymer content).

This is referred to as non-demineralized or partially demineralized polymer, and subsequently as demineralized polymer.

This saves a further purification step. Although an additional washing step may be necessary after step a), the use of a non-desalinated polymer drastically reduces the cost of producing the coating polymer (e.g. PVA, polyvinyl amine). This makes the process more economical overall.

The simultaneous addition of a crosslinker to a suspension of an organic polymer, preferably a polyamine, at low temperatures of less than or equal to 10° C. during coating (step (a)) slowly forms a hydrogel directly in the pores of the carrier and the polymer is directly immobilized. If a non-desalinated polymer is used, the salts formed during hydrolysis can simply be washed out with water. In addition, the subsequent crosslinking as a result of pre-crosslinking during coating, for example or preferably with epichlorohydrin and diaminoethylene, can be carried out in aqueous suspension and does not have to be carried out in a fluidized bed, as was previously the case in the prior art. This leads to a considerable simplification of the process. When epichlorohydrin is used, carrying out the crosslinking in aqueous suspension also has the advantage that unreacted epichlorohydrin is simply hydrolyzed with the sodium hydroxide solution and thus rendered harmless or converted into harmless substances (glycerol).

### Organic Carrier Material

The organic carrier material is preferably a polystyrene, a sulphonated polystyrene, a polymethacrylate or a strong or weak ion exchanger.

According to a further embodiment, the organic carrier polymer is a strong or a weak cation exchanger which is coated with the polymer only on its outer surface. Strong cation exchangers are organic polymers that have sulphonic acid groups. Weak cation exchangers are polymers that have carboxylic acid groups.

Until now, it was only known that the so-called MetCap® particles can successfully remove bacteria from solutions (DE102017007273.6), which are either based on silica gel or do not require a carrier. Production and proof of activity are disclosed in DE102017007273.6. There, the coating of silica gel particles (as a template) with non-desalinated polymer and subsequent dissolution of the inorganic carrier and its antibacterial activity are described.

For particles based on an organic carrier, such as polystyrene, no corresponding activity was previously known. Surprisingly, this activity has now been observed on the polystyrene-based resin produced using the new process. This observation is surprising because polystyrene usually tends to form a pronounced biofilm and does not remove viruses or bacteria. Furthermore, in contrast to the carriers used to date, polystyrene is highly lipophilic and therefore has completely different properties to the carriers used to date.

A simplification of the manufacturing process using polystyrene-based resins is achieved by dispensing with the desalination of the polymer hydrolysate as well as other process modifications, which relate in particular to the addition and drying of the carrier polymers to the polymer solution.

Surprisingly, it is possible to produce MetCap® and BacCap® resins without prior desalination of the polymer solution by immobilization on porous polystyrene particles. This is all the more surprising as previous studies have found a clear dependence of the deposition or immobilization rate of the polymer on the porous carrier on the salt content of the polymer hydrolysate.

By adapting the coating process (e.g. multiple coating, drying in the Loedige ploughshare mixer, introduction of new washing strategies), it was possible to dispense with the complex and costly process step of desalinating the polymer hydrolysate without having to accept restrictions in the performance of the products.

To summarize, it can be said that the change in the manufacturing process, in particular the elimination of desalination by membrane filtration and the extension to organic carrier materials, brings decisive advantages.

The polymer content is now determined by the batch calculation during polymerization. To the surprise of the authors, coating and pre-crosslinking with ethylene glycol diglycidyl ether in the Loedige vacuum paddle dryer works in exactly the same way as with the polyvinyl-amine polymer solution, which does not contain any salts. The salts contained are then partially dissolved out during the preparation of the suspension for post-crosslinking. After the silica gel of the carrier has been dissolved with the help of the sodium hydroxide solution, all salts (silicates, formates, chlorides, etc.) are rinsed out of the cross-linked, purely organic template material. The resulting BacCap® T or MetCap® T material has the same properties as the absorber resins produced using the desalinated PVA polymer process. This is the first improvement in the process, which comes as a great surprise because the previous assumption, also supported by literature data, was that the volume requirement of the highly concentrated salts in the polymer solution prevented effective and complete filling of the particles with polymer, solely due to its space requirement.

The second method concerns the coating of commercial strong or weak ion exchangers with an antiviral and antibacterial PVA polymer shell.

Commercial ion exchangers, especially the cation exchangers used here, generally have acid groups that are covalently bonded to the polymer carrier (e.g. polystyrene, acrylates, etc.). The acid groups are carboxylic acids or carboxylates in the case of weak ion exchangers or sulphonic acids or sulphonates in the case of strong ion exchangers. Both types are used in the softening of drinking water.

In order to provide these ion exchangers with antiviral and antibacterial properties and at the same time not significantly reduce their softening capacity, only an external coating of the particles is sought without modifying the acid groups in the pores of the particles, where the majority of the capacity-carrying acid groups are located.

This goal is achieved by using an appropriate polymer that cannot penetrate the pores of the ion exchange particles due to its size and hydrodynamic radius. The pore sizes of commercial ion exchangers are in the range of 20 nm to 100 nm. These pores are inaccessible for polymers with a size of 10,000-20,000 g/mol.

In a preferred embodiment of this procedure, only the outer 2-25% of the particle, measured by the radius of the particle, is coated. More preferably, only the outer 2-10% of the particle measured by the radius of the particles are coated. Most preferably, only the outer 2-5% of the particle measured by the radius is coated.

In this way, the vast majority of the groups capable of ion exchange remain available for softening the water.

The non-desalinated polymer of the appropriate size can also be used for this purpose, but this is not a mandatory requirement. Coating with demineralized polymer is also possible, as is the use of non-demineralized polymer.

After hydrolysis of the amide groups of the polyvinylamide with sodium hydroxide solution and subsequent blunting with hydrochloric acid, the polymer contains approx. 15-25% by weight of salt in the form of sodium formate and common salt. The polymer content of the aqueous solution corresponds to 9-13% by weight in the case of the undesalinated polymer.

In previous processes, the salts were laboriously removed by reverse osmosis and the polymer was used with a salt content of less than 2.5% by weight. The new process makes it possible to dispense with this complex and expensive demineralization step. It is therefore preferable with the new process to use the polymer partially demineralized with a salt content of 2.5-15% by weight. It is more preferable to use a partially demineralized polymer with a salt content of 10-15% by weight. It is most preferable to use a non-desalinated polymer with a salt content of 15-25% by weight.

### Inorganic Carrier Material

The inorganic carrier material in particle form is a macro-porous, meso-porous or non-porous carrier material, preferably a meso-porous or macro-porous carrier material. The average pore size of the porous carrier material is preferably in the range from 6 nm to 400 nm, more preferably in the range from 8 to 300 nm and most preferably in the range from 10 to 150 nm. For industrial applications, a particle size range of 100 to 3000 nm is also preferred. Furthermore, it is preferred that the porous carrier material has a pore volume in the range from 30 vol. % to 90 vol. %, more preferably from 40 to 80 vol. % and most preferably from 60 to 70 vol. %, in each case based on the total volume of the porous carrier material. The average pore size and the pore volume of the porous carrier material can be determined by the pore filling method with mercury according to DIN 66133.

In a further embodiment, the inorganic carrier material is non-porous, i.e. its pore size is in the range of less than 4 nm.

The porous inorganic material is preferably one that can be dissolved in aqueous-alkaline conditions at pH greater than 10, more preferably pH greater than 11 and most preferably pH greater than 12.

According to a further embodiment, the preferably porous inorganic carrier material is dissolved at a pH>10. This enables the creation of a porous hydrogel, which increases the accessibility and capacity for metal ions and biological impurities. The dissolution of the inorganic carrier material preferably takes place before step (c), the protonation.

In other words, the step of dissolving out the inorganic carrier material while maintaining the porous particles from a cross-linked polymer takes place in said aqueous-alkaline conditions. The porous inorganic material is preferably one based on silicon dioxide or silica gel, or consists thereof.

The removal of the inorganic carrier material after step (b) and before step (c) means that the inorganic carrier material is removed from the composite particles of porous inorganic carrier material obtained after step (b) and the applied polyamine. The step of dissolving out the inorganic carrier material while retaining the porous particles from a crosslinked polymer is preferably carried out in an aqueous alkaline solution with a pH greater than 10, more preferably pH greater than 11, even more preferably pH greater than 12. An alkali metal hydroxide, more preferably potassium hydroxide or sodium hydroxide, even more preferably sodium hydroxide, is preferably used as the base. It is preferred that the concentration of the alkali hydroxide in the aqueous solution is at least 10 wt. %, even more preferably 25 wt. %, based on the total weight of the solution. In step (c) of the process according to the invention, the particles obtained from step (b) are brought into contact with the corresponding aqueous alkaline solution for several hours. Subsequently, the dissolved inorganic carrier material is washed with water from the porous particles of the crosslinked polymer for such a long time that the inorganic carrier material is essentially no longer contained in the product. This has the advantage that when the porous particles produced according to the invention from a cross-linked polymer are used, for example as a binding material for metals, this only consists of organic material and can therefore be incinerated completely or without residue while retaining or recovering the metals.

The porous inorganic carrier material is preferably a particulate material with an average particle size in the range from 5 μm to 2000 μm, more preferably in the range from 10 μm to 1000 μm. The shape of the particles can be spherical (spherical), rod-shaped, lenticular, donut-shaped, elliptical or even irregular, with spherical particles being preferred.

### Coating and Crosslinking

The proportion of polyamine used in step (a) is in the range from 5% to 50% by weight, more preferably from 10% to 45% by weight and even more preferably from 20% to 40% by weight, in each case based on the weight of the porous inorganic or organic carrier material without polyamine.

The application of the polyamine to the carrier material in particle form in step (a) of the method according to the invention can be carried out by various methods, such as impregnation methods or by the pore filling method, the pore filling method being preferred. The pore-filling method has the advantage over conventional impregnation methods that a larger total amount of dissolved polymer can be applied to the porous inorganic carrier material in one step, which increases the binding capacity and simplifies the conventional method.

In all conceivable processes in step (a), the polymer must be dissolved in a solvent. The solvent used for the polymer applied in step (a) is preferably one in which the polymer is soluble. The concentration of the polymer for application to the porous inorganic carrier material is preferably in the range from 5 g/L to 200 g/L, more preferably in the range from 10 g/L to 180 g/L, most preferably in the range from 30 to 160 g/L.

The pore filling method is generally understood to be a special coating process in which a solution containing the polymer to be applied is applied to the porous inorganic substrate in an amount corresponding to the total volume of the pores of the porous substrate. The total volume of the pores [V] of the porous inorganic carrier material can be determined by the solvent absorption capacity (CTE) of the porous inorganic carrier material. The relative pore volume [vol. %] can also be determined. In each case, this is the volume of the freely accessible pores of the carrier material, as only this can be determined by the solvent absorption capacity. The solvent absorption capacity indicates the volume of solvent required to completely fill the pore space of one gram of dry sorbent (preferably stationary phase). Both pure water or aqueous media and organic solvents with high polarity such as dimethylformamide can be used as solvents. If the sorbent increases its volume during wetting (swelling), the amount of solvent used is automatically recorded. To measure the CTE, a precisely weighed quantity of the porous inorganic carrier material is moistened with an excess of well-wetting solvent and excess solvent is removed from the intermediate grain volume in a centrifuge by rotation. The solvent within the pores of the sorbent remains in the pores due to the capillary forces. The mass of the retained solvent is determined by weighing and converted into volume using the density of the solvent. The CTE of a sorbent is reported as volume per gram of dry sorbent (mL/g).

During the crosslinking in step (b), the solvent is removed by drying the material at temperatures in the range from 40° C. to 100° C., more preferably in the range from 50° C. to 90° C. and most preferably in the range from 50° C. to 75° C. In particular, drying is carried out at a pressure in the range from 0.01 to 1 bar, more preferably at a pressure in the range from 0.01 to 0.5 bar.

The crosslinking of the polyamine in the pores or the accessible surface of the inorganic or organic carrier material in step (b) of the process according to the invention is preferably carried out in such a way that the degree of crosslinking of the polyamine is at least 10%, based on the total number of crosslinkable groups of the polyamine. The degree of crosslinking can be adjusted by the corresponding desired amount of crosslinking agent. It is assumed that 100 mol % of the crosslinking agent reacts and forms crosslinks. This can be verified by analytical methods such as MAS-NMR spectroscopy and quantitative determination of the amount of crosslinking agent in relation to the amount of polymer used. This method is preferable according to the invention. However, the degree of crosslinking can also be determined by IR spectroscopy in relation to C—O—C or OH vibrations, for example, using a calibration curve. Both methods are standard analytical methods for a person skilled in the art. The maximum degree of crosslinking is preferably 60%, more preferably 50% and most preferably 40%. If the degree of crosslinking is above the specified upper limit, the polyamine coating is not sufficiently flexible. If the degree of crosslinking is below the specified lower limit, the resulting porous particles from the crosslinked polyamine are not rigid enough to be used, for example, as particles of a chromatographic phase or in a water purification cartridge, in which higher pressures are sometimes also applied. If the resulting porous particles from the cross-linked polyamine are used directly as material for an anti-bacterial or anti-viral absorber resin, the degree of cross-linking of the polyamine is preferably at least 20%.

The crosslinking agent used for crosslinking preferably has two, three or more functional groups, through the bonding of which to the polyamine the crosslinking takes place. The crosslinking agent used to crosslink the polyamine applied in step (b) is preferably selected from the group consisting of dicarboxylic acids, tricarboxylic acids, urea, bis-epoxides or tris-epoxides, diisocyanates or triisocyanates, dihaloalkyls or trihaloalkyls and haloepoxides, wherein dicarboxylic acids, bis-epoxides and haloepoxides are preferred, such as terephthalic acid, biphenyldicarboxylic acid, ethylene glycol diglycidyl ether (EGDGE), 1,12-bis-(5-norbornene-2, 3-dicarboximido)-decanedicarboxylic acid and epichlorohydrin, wherein ethylene glycol diglycidyl ether, 1,12-bis-(5-norbornene-2,3-dicarboximido)-decanedicarboxylic acid and epichlorohydrin are more preferred. In one embodiment of the present invention, the crosslinking agent is preferably a linear molecule having a length of between 3 and 20 atoms.

The polyamine used in step (a) preferably has one amino group per repeating unit. A repeating unit is understood to be the smallest unit of a polymer which is repeated at periodic intervals along the polymer chain. Polyamines are preferably polymers that have primary and/or secondary amino groups. It can be a polymer consisting of the same repeating units, but it can also be a co-polymer which preferably has as co-monomers simple alkene monomers or polar, inert monomers such as vinylpyrrolidone.

Examples of polyamines are the following: Polyamines, such as any polyalkylamines, e.g. polyvinylamine, polyalkylamine, polyethyleneimine and polylysine, etc. Among these, polyalkylamines are preferred, polyvinylamine and polyallylamine are even more preferred, polyvinylamine being particularly preferred.

The preferred molecular weight of the polyamine used in step (a) of the process according to the invention is preferably in the range from 5,000 to 50,000 g/mol, which applies in particular to the polyvinylamine indicated.

Furthermore, the crosslinked polyamine can be derivatized in its side groups after step (b). Preferably, an organic residue is bound to the polymer. This radical can be any conceivable radical, such as an aliphatic and aromatic group, which can also have heteroatoms. These groups can also be substituted with anionic or cationic radicals or protonatable or deprotonatable radicals. If the crosslinked porous polyamine obtained according to the method of the invention is used to bind metals from solutions, the group with which the side groups of the polymer are derivatized is a group which has the property of a Lewis base. An organic residue which has the property of a Lewis base is understood to mean, in particular, residues which form a complex bond with the metal to be bound. Organic radicals which have a Lewis base are, for example, those which have heteroatoms with free electron pairs, such as N, O, P, As or S.

Preferred organic residues for the derivatization of the polymer are the ligands shown below:

| Name | Structure of the ligand on the polymer |
|---|---|
| 6-aminonicotinic acid groups | 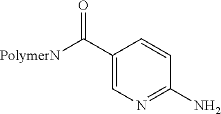 |
| Arginine groups | 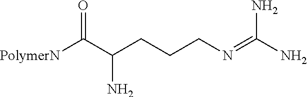 |
| Succinic acid N-methyl piperazine | 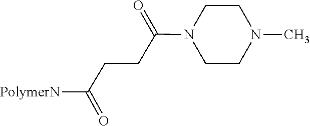 |
| 4-[(4-aminopiperazin-1- yl)amino]-4-oxobutanoic acid groups | 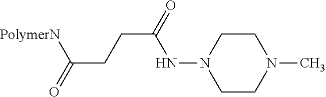 |
| Succinic acid groups | 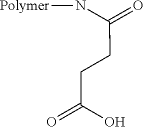 |
| Creatine groups | 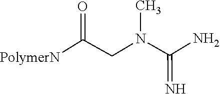 |
| Diaminobicyclooctanecarboxylic acid | 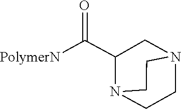 |
| Diethylenetriamine | 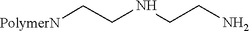 |
| Diglycolic acid groups | 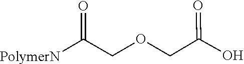 |
| Ethylenediaminetetraacetic acid groups Bonding can take place to 1-4 acid groups | 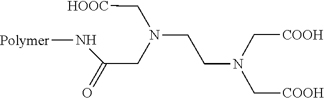 |
| Ethylphosphonylcarbonyl group | 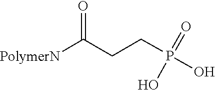 |
| N-ethanethiol groups | 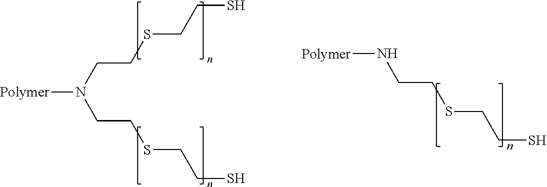 |
| | ₙ ≥ 0 |
| N,N-diethanoic acid groups The chloroacetic acid can mono- or di-substitute the amino group (EtSr) | 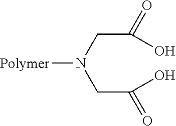 |
| | 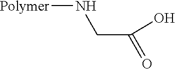 |
| 4-aminobutyric acid groups | 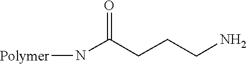 |
| Glutaric acid groups | 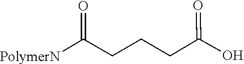 |
| 4-piperidinecarboxylic acid groups | 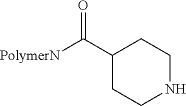 |
| 4-imidazolyl acrylic acid groups | 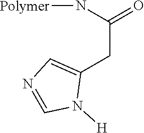 |
| 4-imidazolyl acrylic acid groups | 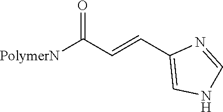 |
| Isonicotinic acid groups | 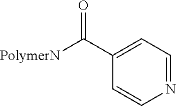 |
| Lysinic acid groups | 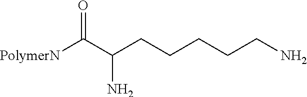 |
| Methylthiourea groups | 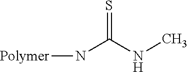 |
| Nitrilotriacetic acid Binding takes place via 1-3 carboxylic acid groups | 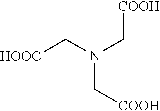 [SMILES: O=C(O)CN(CC(=O)O)CC(=O)O] |
| Phosphoric acid group Can have a cross-linking effect. | 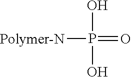 |
| | 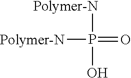 |
| | 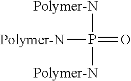 |
| Proline | 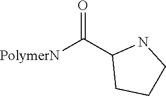 |
| Purine-6-carboxylic acid groups | 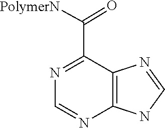 |
| Pyrazine-2-carboxylic acid groups | 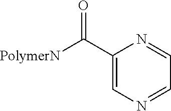 |
| Thymine-N-acetic acid groups | 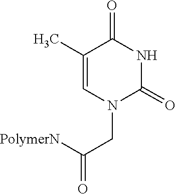 |
| Theophylline-7-acetic acid groups | 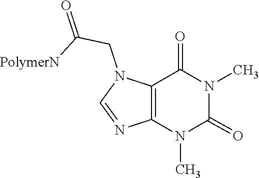 |
| Citric acid groups | 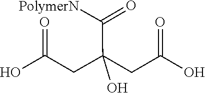 |

Particularly preferred are the ligands PVA, i.e. the amino group of PVA, EtSr, NTA, EtSH, MeSH, EDTA and iNic or combinations of the above. For example, a combination of PVA with EtSr, NTA or EtSH is particularly preferred.

Polyvinylamine is particularly preferably used as the polymer in the process according to the invention, since the amino groups of the polyvinylamine themselves represent Lewis bases and can also be easily coupled to a molecule with an electrophilic center due to their property as nucleophilic groups. Preferably, coupling reactions are used in which a secondary amine and not an amide is formed, since the Lewis basicity is not lost due to the formation of a secondary amine.

The present invention also relates to antiviral particles of a crosslinked polymer which are obtainable or prepared according to the above method according to the invention. In this context, it is preferred that the particles prepared according to the method of the invention have a maximum swelling factor in water of 300%, assuming that a value of 100% applies to the dry particles. In other words, the particles according to the invention can increase in volume by a maximum of three times in water.

A further object of the present application is also antiviral particles of a cross-linked polyamine, these particles also having a maximum swelling factor of 300%, assuming that the percentage of dry particles is 100%. In other words, these porous particles according to the invention can also have a maximum increase in volume by a factor of three when swelling in water.

However, it is even more preferred that the antiviral particles produced according to the method according to the invention or the antiviral particles according to the invention have a maximum swelling factor in water of 250%, even more preferably 200% and most preferably less than 150%, since otherwise the rigidity of the particles obtained is not sufficiently high, at least for chromatographic applications and in pressurized drinking water cartridges.

The biocidal (antiviral and antibacterial) particles produced according to the method of the invention are preferably produced from a cross-linked polyamine. The polyamine or the porous particles consisting thereof preferably have a concentration of the amino groups, determined by titration, of at least 300 μmol/mL, more preferably at least 600 μmol/mL, and even more preferably at least 1000 μmol/mL. The concentration of amino groups determined by titration is understood to be the concentration obtained by breakthrough measurement with 4-toluenesulphonic acid according to the analytical methods given in the example part of this application.

The particles produced according to the invention preferably have a dry bulk density in the range from 0.25 g/mL to 0.8 g/mL, even more preferably 0.3 g/mL to 0.7 g/mL. In other words, the porous particles are extremely light particles overall, which is ensured by the high porosity obtained. Despite the high porosity and low weight of the particles, they have a relatively high mechanical strength or rigidity and can also be used in applications as resins under pressure.

The average pore size of the particles produced according to the invention or according to the invention, determined by inverse size exclusion chromatography, is preferably in the range from 1 nm to 100 nm, more preferably 2 nm to 80 nm.

According to one embodiment, the antiviral particles produced according to the invention are preferably particles which have a shape similar to that of the dissolved porous inorganic carrier material, but with the proviso that the particles according to the invention essentially reflect the pore system of the dissolved porous inorganic carrier material with their material, i.e. in the case of the ideal particles, they have a shape similar to that of the dissolved porous inorganic carrier material. i.e. in the case of ideal pore filling in step (b) of the method according to the invention, they are the inverse pore image of the porous inorganic carrier material used. The porous particles according to the invention are preferably present in an essentially spherical form. Their average particle size is preferably in the range from 5 μm to 1000 μm, more preferably in the range from 100 to 500 μm.

Furthermore, the particles of the crosslinked polymer according to the invention according to one embodiment are characterized in that they consist essentially of the crosslinked polymer. “Essentially” in this case means that only unavoidable residues of, for example, inorganic carrier material may still be present in the porous particles, the proportion of which, however, is preferably below 2000 ppm, even more preferably 1000 ppm and most preferably 500 ppm. In other words, it is preferred that the porous particles of the crosslinked polymer according to the invention are substantially free of an inorganic material, such as the material of the inorganic carrier material. This is also meant above in connection with step (c) of the method according to the invention, when it is mentioned that the inorganic carrier material is essentially no longer contained in the product.

A further embodiment of the present invention relates to the use of the particles according to the invention or the particles produced according to the invention for removing viruses and biological impurities and for separating metal ions from solutions, in particular water. Here, the particles according to the invention or the particles produced according to the invention are preferably used in filtration processes or solid phase extraction, which allow the removal of viruses and biological impurities from water or the separation of metal-containing ions from solutions. For example, the material according to the invention can be used in a simple way in a stirred tank or fluidized bed application, where the material is simply added to a biologically contaminated and metal-containing solution and stirred for a certain time.

The present invention also relates to a filter cartridge, for example for the treatment of drinking water, which contains particles according to the invention. The filter cartridge is preferably shaped in such a way that the drinking water to be treated can pass through the cartridge and come into contact with the particles according to the invention in its interior, whereby biological impurities and viruses are removed and metal-containing ions are removed from the water.

The filter cartridge can contain an additional material for removing micropollutants. Activated carbon is preferably used for this purpose. The different materials can be arranged in separate zones within the filter cartridge or in a mixture of the two materials. The filter cartridge can also contain several different materials (with and without derivatization) that have been produced according to the method of the invention.

The filter cartridge can be designed in all conceivable sizes. For example, the filter cartridge can be designed in a size that is sufficient for the daily drinking water requirements in a household. However, the filter cartridge can also be of a size that allows the drinking water requirements of several households to be covered, i.e. a requirement of more than 5 litres per day, for example.

The filter cartridge can, for example, have the shape of a cylinder with a linear flow or the shape of a hollow cylinder with a radial flow.

The present invention will now be explained with reference to the following examples, which are, however, to be regarded only as exemplary:

### Example 1

1712 g of moist carrier material ion exchanger Lewatit S1567 (monodisperse cation exchanger, Lanxess) are conveyed directly into a ploughshare mixer VT5 from Loedige. The ion exchanger is then dried at 80° C. for 60 minutes. The moisture loss is determined by weighing the dried ion exchanger. 380 g of water were removed. The product temperature in the dryer is set to 10° C. The mixer is operated at 180 revolutions per minute. After the product temperature in the mixing drum has reached 10° C., 350 ml of a coating solution cooled to 10° C. is added. For the solution, 225 g of undesalted polyvinylamine solution Lot.: PC 18007 (polymer content 10%) and 1 g of ethylene glycol di-glycidyl ether (EGDGE) [2224-15-9] are weighed into a container and deionized water is added until a total volume of 350 ml is reached. The mixture is added to the mixer within 10 min and mixed for 1 h at 10° C. The polymer adsorbate is then crosslinked at 80° C. and a reduced pressure of 50 mbar for 2 hours. The polymer-coated ion exchanger was then cooled down to room temperature.

The particles are then transferred to suitable filter slides and washed with the following solvents (BV=bed volume): 3 BV 0.1 M NaOH, 3 BV deionized water, 6 BV 0.1 M NaOH, 3 BV water, 3 BV 0.2 M HCl, 6 BV deionized water. The product is obtained as a water-wet particle.

### Example 2

3 litres of Lewatit S 8227 (macroporous, weakly acidic cation exchange resin based on a cross-linked acrylate) from Lanxess are washed on a frit with porosity 3 with 15 liters of demineralized water. Then 2270 g of moist ion exchanger are weighed into a vacuum paddle dryer VT 5 from Loedige. The ion exchanger is dried at a jacket temperature of 80° C., a pressure of 30 mbar and a speed of 57 rpm for 2 hours. After drying, 915 g of dried ion exchanger is filled back into the VT 5 vacuum paddle dryer. The jacket temperature is set to 4° C. and if the product temperature is below 20° C., 600 ml of demineralized water is pumped into the mixer, which is operated at a speed of 180 rpm, within 15 minutes using a peristaltic pump. For the coating, 227 g of polyvinylamine solution (polymer content 10%) Lot: PC 18007 and 227 g of demineralized water are weighed into a container. As a crosslinker, 9.20 g of ethylene glycol di-glycidyl ether (EGDGE) [2224-15-9] is weighed into another vessel. The crosslinker is added to the polymer solution and mixed intensively. The mixture is then pumped into the Loedige mixer within 5 minutes using a peristaltic pump. The speed of the mixer is set to 240 rpm and the jacket temperature is left at 4° C. After the addition, the mixture is mixed for another 15 minutes at 240 rpm. The jacket temperature on the dryer is then set to 80° C. and the speed is reduced to 120 rpm. The particles are then cooled back down to room temperature and then transferred to suitable filter nutsches and washed with the following solvents: 3 BV 0.1 M NaOH, 3 BV deionized water, 6 BV 0.1 M NaOH, 3 BV water, 3 BV 0.2 M HCl, 6 BV deionized water. The product is obtained as a water-wet particle.

### Example 3

500 g of carrier material sulfonated polystyrene PRC 15035 (average pore size 450 Å, average particle size 500 μm) with a water absorption capacity of 1.35 ml/g are directly sucked into a ploughshare mixer VT5 from Loedige. The product temperature in the dryer is set to 10° C. The mixer is operated at 180 revolutions per minute. After the product temperature in the mixing drum has reached 10° C., 225 g of non-desalinated polyvinylamine solution Lot.: PC 16012 (polymer content 12%), 20 g of ethylene glycol di-glycidyl ether (EGDGE) CAS No. [2224-15-9] and 430 g of deionized water are weighed into a container. The mixture is added to the mixer within 10 min and mixed for 1 h at 10° C. The polymer adsorbate is then crosslinked at 65° C. The product is then cooled down to room temperature. The particles are then transferred to a suitable filter slide and washed with the following solvents: 3 BV 0.1 M NaOH, 3 BV deionized water, 6 BV 0.1 M NaOH, 3 BV water, 3 BV 0.2 M HCl, 6 BV deionized water. 1297 g of product is obtained as a water-wet particle. Anionic capacity (AIC): 471 μmol/g.

### Example 4

Instruction for the preparation of a porous particle of a cross-linked polymer with 100 μm particle size (Batch: BV 18007): 1. Preparation of polymer adsorbate: 750 g carrier material silica gel (AGC Si-Tech Co. M.S Gel D-200-100 Lot.: 164M00711) is fed directly into a ploughshare mixer VT5 from Loedige. The product temperature is set to 10° C. The mixer is operated at 180 revolutions per minute. After the product temperature in the mixing drum has reached 10° C., 1125 g of non-desalinated polyvinylamine solution Lot.: PC 18007 (polymer content 10%) cooled to 10° C. is weighed into a vessel and mixed with 23.2 g of ethylene glycol di-glycidyl ether (EGDGE) CAS No. [2224-15-9]. The mixture is added to the mixer within 10 min and mixed for 1 h at 10° C. The polymer adsorbate is then dried at 80° C. and 50 mbar (approx. 2 h). The coated silica gel was then cooled down to 10° C. For the second coating, 750 g of polymer solution PC 18007 (polymer content 10%) cooled to 10° C. was weighed into a container and mixed with 15 g of ethylene glycol di-glycidyl ether (EGDGE) CAS no. [2224-15-9]. The polymer solution was filled into the mixing drum within 5 min. The polymer adsorbate was mixed for 30 min at 10° C. The temperature in the Loedige mixer was then increased again to 65° C. for 1 hour. The polymer adsorbate was mixed with 3 liters of deionized water. This suspension is used for crosslinking. The coated silica gel suspended in water is transferred to a 10 liter glass reactor with automatic temperature control. The suspension is stirred and heated to 80° C. Then 317 g of epichlorohydrin CAS no. [106-89-8] is added within 20 min so that the temperature in the reactor does not exceed 85° C. Then 211 g of 1,2-diaminoethane [107-15-3] is added within 20 minutes. Then 317 g of epichlorohydrin CAS No. [106-89-8] is added for the second time within 20 minutes, followed by another 211 g of 1,2-diaminoethane CAS No. [107-15-3]. Finally, 317 g of epichlorohydrin CAS No. [106-89-8] is added and the reaction is stirred for 1 h at 85° C. The reaction mixture is then cooled to 25° C., and 1500 ml of 50% NaOH is added and reaction mixture is stirred for 12 hours. The template particles are then transferred to suitable filter slides and washed with the following solvents: 3 BV 0.1 M NaOH, 3 BV deionized water, 6 BV 0.1 M NaOH, 3 BV water, 3 BV 0.2 M HCl, 6 BV deionized water.

The product is obtained as a moist filter cake.

### Example 5

An aqueous suspension of each of the resins is prepared from crosslinked polyvinylamine (BV 16037, BV 16084, BV 18002 and BV 18009 coated on the outside only).

A suspension of adenoviruses is then added and shaken at room temperature for a certain period of time.

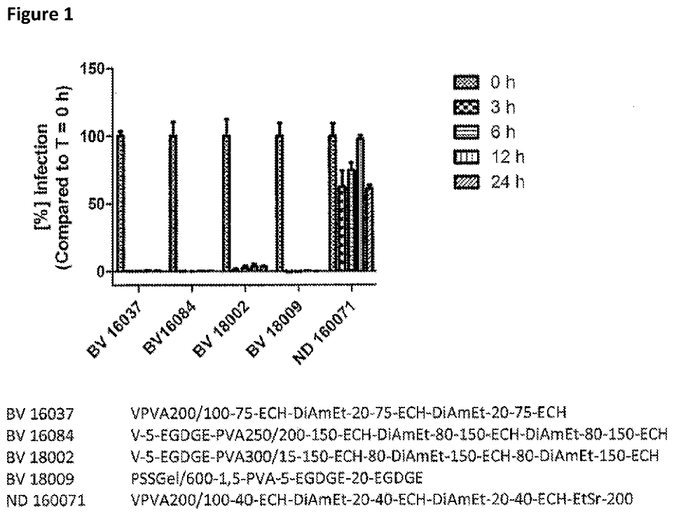

The results of the tests are shown in FIG. 1: No viruses are detectable in the effluent over the entire test range. This means that the viruses are completely removed in drinking water-relevant concentrations.

As can be seen in FIG. 1, the viral load of the resins used drops to zero or close to zero within 3 hours.

The antiviral effect of the resins claimed in the present application, i.e. the cross-linked polyamines and the coated polystyrenes, has thus been proven.

### Example 6

A suspension of adenoviruses is passed through a column filled with the resins of Example 6 and filtered. After passing through the resin bed, no more viruses are detectable.

The use of the antiviral particles according to the invention thus allows the removal of viruses from drinking water by a simple filtration step.

This results in the following advantages over previously known methods:
Complete removal of viruses (and also bacteria) through binding/killing
No addition of chemical additives
Gravity operation possible
Low to no energy consumption
No pump or UV irradiation necessary
100% yield based on the water used
Chemical regeneration of the resin possible by rinsing with hydrochloric acid/soda lye
Simultaneous removal of bacteria, viruses and heavy metals by adding other resins from the applicant
Use of inexpensive single-use materials is possible

1. A process for production of antiviral particles comprising the steps of
(a) preparing an aqueous suspension comprising a polyamine, a crosslinking agent and an inorganic carrier material or an organic carrier material in particle form at a temperature of less than or equal to 10° C. in a mixer for coating the inorganic carrier material or the organic carrier material with the polyamine;
(b) crosslinking the polyamine of the coated inorganic carrier material or the coated organic carrier material and simultaneously removing water,
(c) protonating the crosslinked polyamine to obtain antiviral particles.

2. The process according to claim 1, wherein steps a) and b) are repeated at least once.

3. The process according to claim 1, wherein the crosslinking takes place in a stirred reactor.

4. The process according to claim 1, wherein the polyamine is used in the demineralized or non-demineralized state.

5. The process according to claim 1, wherein the inorganic carrier material is porous.

6. The process according to claim 1, wherein the inorganic carrier material is a material which can be dissolved in aqueous alkaline conditions at pH>10.

7. The process according to claim 5 further comprising the step of dissolving out the inorganic carrier material after step (b) and before step (c) at a pH>10 to obtain particles of a crosslinked polyamine having an inverse pore structure of the inorganic carrier material.

8. The process according to claim 1, wherein the organic carrier material is a polystyrene, a sulphonated polystyrene, a polymethacrylate or a strong or weak ion exchanger.

9. The process according to claim 1, wherein the polyamine is a polyvinylamine.

10. The process according to claim 1, wherein the crosslinked polyamine obtained in step (b) has side groups and the side groups are derivatized after step (c).

11. Antiviral particles prepared by the process according to claim 1.

12. The antiviral particles according to claim 11, wherein the polyamine obtained in step (b) of claim 1 is at least partially protonated.

13. The antiviral particles according to claim 11, wherein the particles have a maximum swelling factor in water of 300%, starting from 100% dry particles.

14. The antiviral particles according to claim 11, wherein the dry bulk density is in the range from 0.25 g/ml to 0.8 g/mL.

15. A method for removing viruses from water comprising bringing water contaminated with bacteria, germs, yeasts or fungi into contact with the antiviral particles according to claim 11.

16. The method according to claim 15, wherein the method comprises removing bacteria, germs, yeasts or fungi from the water contaminated with bacteria, germs, yeasts or fungi.

17. The method according to claim 15, wherein the water contaminated with bacteria, germs, yeasts or fungi is brought into contact with the antiviral particles at a pH in the range from 6 to 9.

18. A filter cartridge comprising antiviral particles according to claim 11.

19. A filter cartridge comprising antiviral particles according to claim 12.
